(19) United States
(12) Patent Application Publication
(10) Pub. No.: US 2026/0192431 A1
(43) Pub. Date: Jul. 9, 2026

(54) HANDHELD POWER TOOL

(71) Applicant: HUSQVARNA AB, Huskvarna (SE)

(72) Inventors: Mikael LARSSON, Huskvarna (SE); Tobias STALFORS, Huskvarna (SE)

(21) Appl. No.: 19/131,620

(22) PCT Filed: Aug. 21, 2023
(86) PCT No.: PCT/SE2023/050845

§ 371 Date: May 21, 2025

(30) Foreign Application Priority Data
Nov. 21, 2022 (SE) 2251362-6

(51) Int. Cl. B25F 5/02; B23D 59/00; B27B 17/00; B27G 19/00

(52) U.S. Cl. CPC B25F 5/02; B23D 59/001; B27B 17/0008; B27G 19/003

(57) ABSTRACT

A handheld power tool (1) is disclosed comprising a tool (30), a power source (10) configured to power the tool (30), a first handle (h1), and a second handle (h2) arranged at a distance from the first handle (h1). The handheld power tool (1) is configured to be supported via each of the first and second handles (h1, h2) during operation of the handheld power tool (1). The handheld power tool (1) further comprises a first sensor assembly (a1) configured to provide data representative of an external force (Fe1, Fe1′) applied onto the first handle (h1), and a second sensor assembly (a2) configured to provide data representative of an external force (Fe2, Fe2′) applied onto the second handle (h2).

### TECHNICAL FIELD

The present disclosure relates to a handheld power tool comprising a tool, a power source configured to power the tool, a first handle, and a second handle arranged at a distance from the first handle.

### BACKGROUND

A handheld power tool is a tool intended to be supported by one or two hands of a user during operation. Moreover, a handheld power tool comprises a tool which can be driven by a power source other than solely manual labour. The power source may for example comprise a combustion engine, an electric motor, a pneumatic motor, or the like.

Today, there are many kinds of power tools available on the market. Examples are chain saws, circular saws, jigsaws, trimmers, hedge trimmers, string-trimmers, brush-cutters, multi-tools, and the like. Power tools are for example used in industry, in construction, in gardens, for housework tasks, and around houses for purposes of cutting, shaping, sanding, grinding, routing, polishing, and the like.

Handheld power tools of various kind are associated with some mutual problems. One problem is safety. That is, a power tool can comprise a sharp tool and a powerful power source for powering the tool, which poses a safety risk.

Another problem is ergonomics. That is, handheld power tools can be operated during long periods of times, especially when used by professionals. Therefore, it is an advantage if a handheld power tool can be designed to be operated in a convenient and ergonomic manner.

A further general problem when designing power tools and associated components and assemblies is user-friendliness. That is, it is an advantage if the handheld power tool and associated components and assemblies are designed such that a user can operate the power tool in a simple and intuitive manner.

Another problem, which is at least partially linked to some of the problems specified above, is that it may be difficult to identify when a handheld power tool is used in an incorrect manner.

An incorrect operation of a handheld power tool may put stain on the user and can increase the energy consumption of the handheld power tool for achieving a certain task. Moreover, an incorrect operation of a handheld power tool may impair the operation efficiency as well as the operation result and may lead to potentially dangerous situations.

Still another problem, which is at least partially linked to some of the problems specified above, is that it may be difficult to identify when a tool of the handheld power tool has reduced operational efficiency for example due to wear and tear and/or clogging of matter onto the tool. A reduced operational efficiency of a tool may put strain on the user and can increase the energy consumption of the handheld power tool for achieving a certain task.

Still another problem when designing a handheld power tool is to maintain a low weight of the power tool while adding different features and functions. A low weight of a handheld power tool is preferred because the weight of the power tool puts strain to hands, arms, and back of a user. Moreover, a low weight can allow users to operate the handheld power tool in a safer manner.

In addition, generally, on today's consumer market, it is an advantage if products comprise different features and functions while the products have conditions and/or characteristics suitable for being manufactured and assembled in a cost-efficient manner.

### SUMMARY

It is an object of the present invention to overcome, or at least alleviate, at least some of the above-mentioned problems and drawbacks.

According to an aspect of the invention, the object is achieved by a handheld power tool comprising a tool, a power source configured to power the tool, a first handle, and a second handle arranged at a distance from the first handle. The handheld power tool is configured to be supported via each of the first and second handles during operation of the handheld power tool. The handheld power tool further comprises a first sensor assembly configured to provide data representative of an external force applied onto the first handle, and a second sensor assembly configured to provide data representative of an external force applied onto the second handle.

Since the handheld power tool comprises the first and second sensor assemblies each configured to provide data representative of external forces applied onto the respective first and second handles, and since second handle is arranged at a distance from the first handle, a handheld power tool is provided capable of obtaining current use data of the handheld power tool during operation thereof in a reliable manner.

That is, since the handheld power tool is configured to be supported via each of the first and second handles during operation of the handheld power tool, the data representative of external forces applied onto the first and second handles can give a clear indication of a current use situation of the handheld power tool. As an example, the data representative of external forces applied onto the first and second handles can indicate whether a user is holding the handheld power tool with one hand on each of the first and second handles. Moreover, the data representative of external forces applied onto the first and second handles can indicate whether a user is pressing the tool of the handheld power tool against an object or not. Furthermore, the data representative of external forces applied onto the first and second handles can indicate whether the handheld power tool is used in a correct manner.

Moreover, since the handheld power tool comprises the first and second sensor assemblies each configured to provide data representative of external forces applied onto the respective first and second handles, a handheld power tool is having conditions for improved operational safety. This is because the data representative of external forces applied onto the first and second handles can be utilized to notify a user of the handheld power tool when the data indicates that the user is using the handheld power tool in an incorrect and/or potentially dangerous manner.

Accordingly, a handheld power tool is provided overcoming, or at least alleviating, at least some of the above-mentioned problems and drawbacks. As a result, the above-mentioned object is achieved.

Optionally, the handheld power tool comprises a control arrangement configured to provide a tool force estimate representative of a force applied onto the tool based on the data from the first and second sensor assemblies. Thereby, a handheld power tool is provided capable of providing a reliable tool force estimate in a simple, efficient, and reliable manner. That is, since the handheld power tool comprises the first and second sensor assemblies each configured to provide data representative of external forces applied onto the respective first and second handles, and since second handle is arranged at a distance from the first handle, reliable tool force estimates can be provided by the control arrangement in a simple and efficient manner.

As a further result, a handheld power tool is provided capable of obtaining even more detailed current use data which can provide even clearer indications of current use situations of the handheld power tool and can provide even clearer and more reliable indications of whether the handheld power tool is used in a correct manner.

Optionally, the control arrangement is configured to adjust a power output of the power source based on the tool force estimate. Thereby, conditions are provided for an improved operational efficiency of the handheld power tool. This is because the power output of the power source can be adjusted such that the power output is increased with increasing tool force estimates and vice versa. Accordingly, in this manner, an at least substantially automatic control can be performed of the power output of the power source of the handheld power tool based on the external forces applied onto the first and second handles of the handheld power tool.

In addition, due to these features, a handheld power tool is provided having conditions for being operated in a simpler, more ergonomic, and more user-friendly manner.

Optionally, the tool is arranged to operate in at least two different operational directions, and wherein the tool force estimate is indicative of a current operational direction of the tool. Thereby, a handheld power tool is provided capable of obtaining data indicative of the current operational direction of the tool in a simple, efficient, and reliable manner. As a further result, a handheld power tool is provided capable of obtaining even more detailed current use data which can provide even clearer indications of current use situations of the handheld power tool and clearer and more reliable indications of whether the handheld power tool is used in a correct manner.

Optionally, the control arrangement is configured to estimate an operational efficiency of the tool based on the tool force estimate and on current operational data of the power source. Thereby, a handheld power tool is provided having conditions for providing reliable estimates of the operational efficiency of the tool. As a result, a handheld power tool is provided capable of obtaining even more detailed current use data which can provide even clearer indications of current use situations of the handheld power tool and clearer and more reliable indications of whether the handheld power tool is used in a correct manner. Moreover, conditions are provided for notifying a user of the handheld power tool for example if the operational efficiency of the tool drops below a threshold efficiency.

A reduced operational efficiency of the tool may for example be caused by clogging of the tool and/or wear and tear of the tool. In other words, due to these features, a handheld power tool is provided having conditions for providing reliable estimates of a wear status of the tool and/or a clogging status of the tool.

Optionally, the handheld power tool comprises user interface unit configured to output data indicative of the estimated operational efficiency of the tool. Thereby, a handheld power tool is provided having conditions for being used in a simpler and more user-friendly manner. In addition, a handheld power tool is provided having conditions for a reduced energy consumption. This is because a user can be notified about the operational efficiency of the tool and can perform measures in response thereto, such as for example cleaning, replacing, or sharpening the tool of the handheld power tool.

Optionally, the power source of the handheld power tool comprises an internal combustion engine. According to such embodiments, the current operational data of the power source may comprise one or more of a current rotational speed of the internal combustion engine, a current torque of the internal combustion engine, a current power of the internal combustion engine, a current temperature of the internal combustion engine, a current throttle position of an air supply system of the internal combustion engine, a current throttle position of an actuator for controlling the power output of the internal combustion engine, and the like. In this manner, the operational efficiency of the tool can be estimated in a simple, efficient, and reliable manner.

According to some further embodiments, the power source of the handheld power tool comprises an electric motor. According to such embodiments, the current operational data of the power source may comprise one or more of a current rotational speed of the electric motor, a current torque of the electric motor, a current power of the electric motor, a current temperature of the electric motor, a current throttle position of an actuator for controlling the electric motor, a current electrical voltage supplied to the electric motor, a current electrical current supplied to the electrical motor, and the like. In this manner, the operational efficiency of the tool can be estimated in a simple, efficient, and reliable manner.

Optionally, the handheld power tool comprises a user interface unit configured to output data indicative of the tool force estimate. Thereby, a handheld power tool is provided having conditions for being used in a simpler, more ergonomic, and more user-friendly manner. This is because the output of the data indicative of the tool force estimate can indicate whether an actual force applied onto the tool is within a preferred force range. As a further result, a handheld power tool is provided having conditions for an improved operational efficiency as well as conditions for a reduced wear and tear of the tool. In addition, a handheld power tool is provided having conditions for being operated in a safer manner.

Optionally, the user interface unit is configured to output a first type of signal if the tool force estimate is below a threshold force and is configured to output a second type of signal, being distinguishable from the first type of signal, if the tool force estimate exceeds the threshold force. Thereby, a handheld power tool is provided having conditions for being used in a simpler, more ergonomic, and more user-friendly manner. This is because a user can be notified when the tool force estimate exceeds the threshold force and can, in response thereto, reduce the force applied onto the tool. As a further result, a handheld power tool is provided having conditions for an improved operational efficiency as well as conditions for a reduced wear and tear of the tool. In addition, a handheld power tool is provided having conditions for being operated in a safer manner.

Optionally, the handheld power tool comprises a control arrangement configured to render the power source inoperable in case the data from the first and second sensor assemblies indicates that no external force is applied onto one of the first and second handles. Thereby, a handheld power tool is provided having conditions for a significantly enhanced operational safety. This is because it can be ensured that the handheld power tool is held using one hand on the first handle and one hand on the second handle during operation of the handheld power tool.

Optionally, the handheld power tool comprises a control arrangement configured to render the power source inoperable in case of a detection of a sudden increase in external force applied onto one of the first and second handles. Thereby, a handheld power tool is provided having conditions for a significantly enhanced operational safety. This is because the power source is rendered inoperable in potentially dangerous situations, such as when a sudden increase in external force applied onto one of the first and second handles is caused by a sudden movement of the handheld power tool, such as a sudden rotation of the handheld power tool. Such sudden movements of the handheld power tool may for example occur if the moving tool of the handheld power tool is striking an object at an unfavourable part of the tool causing a so-called kickback of the handheld power tool.

Optionally, the tool is a cutting cool configured to operate in a cutting plane, and wherein each of the first and second sensor assemblies is configured provide data representative of external forces applied to the respective first and second handles in directions parallel to the cutting plane. Thereby, a handheld power tool is provided capable of obtaining current use data of the handheld power tool during operation thereof in an even more efficient and reliable manner. Moreover, the data representative of external forces applied onto the first and second handles can give a more reliable indication of a current use situation of the tool of the handheld power tool. In addition, a handheld power tool is provided having conditions for providing even more reliable tool force estimates representative of a force applied onto the tool based on the data from the first and second sensor assemblies.

Optionally, the cutting plane extends through each of the first and second sensor assemblies. Thereby, a handheld power tool is provided capable of obtaining current use data of the handheld power tool during operation thereof in an even more efficient and reliable manner. Moreover, the data representative of external forces applied onto the first and second handles can give a more reliable indication of a current use situation of the tool of the handheld power tool. In addition, a handheld power tool is provided having conditions for providing even more reliable tool force estimates representative of a force applied onto the tool based on the data from the first and second sensor assemblies.

Optionally, the first handle comprises a gripping portion configured to be gripped by a hand of a user during operation of the handheld power tool, and wherein the first sensor assembly comprises two sensor units arranged on at least substantially opposite sides of the gripping portion of the first handle. Thereby, a handheld power tool is provided capable of obtaining current use data of the handheld power tool during operation thereof in an even more efficient and reliable manner. This is because a gripping force around the gripping portion of the first handle can be compensated for in an estimation of a use aspect of the handheld power tool based on the data representative of external forces applied onto the first handle.

In addition, a handheld power tool is provided having conditions for providing even more reliable tool force estimates representative of a force applied onto the tool based on the data from the first and second sensor assemblies.

Optionally, the handheld power tool comprises a control arrangement configured to provide a first resultant force estimate representative of a resultant force applied onto the first handle by comparing force data obtained from the two sensor units, and wherein the control arrangement is configured to provide a tool force estimate representative of a force applied onto the tool at least partially based on the first resultant force estimate. Thereby, an even more reliable and accurate tool force estimate can be provided representative of a force applied onto the tool. This is because a gripping force around the gripping portion of the first handle can be compensated for when providing the tool force estimate.

Optionally, the second handle comprises a gripping portion configured to be gripped by a hand of a user during operation of the handheld power tool, and wherein the second sensor assembly comprises two sensor units arranged on at least substantially opposite sides of the gripping portion of the second handle. Thereby, a handheld power tool is provided capable of obtaining current use data of the handheld power tool during operation thereof in an even more efficient and reliable manner. This is because a gripping force around the gripping portion of the second handle can be compensated for in an estimation of a use aspect of the use of the handheld power tool based on the data representative of external forces applied onto the first handle. In addition, a handheld power tool is provided having conditions for providing even more reliable tool force estimates representative of a force applied onto the tool based on the data from the first and second sensor assemblies.

Optionally, the handheld power tool comprises a control arrangement configured to provide a second resultant force estimate representative of a resultant force applied onto the second handle by comparing force data obtained from the two sensor units, and wherein the control arrangement is configured to provide a tool force estimate representative of a force applied onto the tool at least partially based on the second resultant force estimate. Thereby, an even more reliable and accurate tool force estimate can be provided representative of a force applied onto the tool. This is because a gripping force around the gripping portion of the second handle can be compensated for when providing the tool force estimate.

Optionally, the first and second sensor assemblies comprises a number of sensor units, and wherein each sensor unit comprises a force sensitive resistor. Thereby, a handheld power tool is provided capable of providing data representative of external forces applied onto the first and second handles in a robust, efficient, and reliable manner. In addition, a handheld power tool is provided having conditions and characteristics suitable for being manufactured and assembled in a cost-efficient manner while being able to provide reliable data representative of external forces applied onto the first and second handles.

In addition, since each sensor unit comprises a force sensitive resistor, a handheld power tool is provided capable of providing data representative of external forces applied onto the first and second handles without significantly adding size or weight to the first and second handles. This is because force sensitive resistors can be provided with a small thickness and weight while being able to provide reliable data representative of external forces applied onto the first and second handles.

Furthermore, since each sensor unit comprises a force sensitive resistor, a handheld power tool is provided having conditions for providing data representative of external forces applied onto curved portions of the first and second handles. This is because force sensitive resistors have a high flexing capability while being able to provide reliable data representative of external forces applied onto the first and second handles.

In addition, due to the high flexing capability, the force sensitive resistor can be integrated in, or can be arranged in close proximity to, a soft outer layer of the respective first and second handles.

Moreover, since each sensor unit comprises a force sensitive resistor, a handheld power tool is provided having a low need for wiring and routing of electrical cables while being able to provide reliable data representative of external forces applied onto the first and second handles. Also for this reason, a handheld power tool is provided capable of providing reliable data representative of external forces applied onto the first and second handles without significantly adding size or weight to the first and second handles and without significantly adding size or weight to the handheld power tool.

Optionally, the handheld power tool comprises a control arrangement configured to adjust a power output of the power source based on the data from the first sensor assembly. Thereby, a handheld power tool is provided having conditions for being operated in a more ergonomic and user-friendly manner. This is because the adjustment of the power output of the power source based on the data from the first sensor assembly circumvents the need for a traditional throttle actuator for adjusting the power output of the power source.

Accordingly, in this manner, conditions are provided for a handheld power tool in which the user does not need to adjust the power output of the power source by actuating a separate actuator, for example using a finger. Instead, the user can be allowed to control the power output of the power source by adjusting the gripping force of the hand gripping the first handle.

As a further result of these features, it can be ensured that the user grips the first handle in a secure manner upon operation of the handheld power tool. In addition, the user is allowed to grip the first handle of the handheld power tool with all fingers of a hand in a secure manner during operation of handheld power tool.

Furthermore, since the need for a traditional throttle actuator is circumvented for adjusting the power output of the power source, a handheld power tool is provided having conditions and characteristics suitable for being manufactured and assembled in a cost-efficient manner. In addition, a handheld power tool is provided having conditions for a low weight.

Optionally, the handheld power tool comprises a third sensor assembly and a control arrangement operably connected to the third sensor assembly, the third sensor assembly comprising at least one force sensitive resistor, and wherein the control arrangement is configured to adjust a setting, or switch between at least two different states, based on input from the third sensor assembly. Thereby, the third sensor assembly can function as a robust, efficient, and reliable input unit for the control of the control arrangement. Moreover, since the third sensor assembly comprises at least one force sensitive resistor, the third sensor assembly can be made compact and light weighted.

In addition, due to the high flexing capability of a force sensitive resistor, the force sensitive resistor can be integrated in, or can be arranged in close proximity to, a soft outer layer of the handheld power tool. Moreover, a handheld power tool is provided having a low need for wiring and routing of electrical cables to the third sensor assembly. Moreover, the third sensor assembly can be provided with variable switch limits allowing input based on a pressing force against the third sensor assembly.

Optionally, the handheld power tool is a chain saw or a power cutter. Thereby, a chain saw or power cutter is provided having at least some of the above mentioned advantages.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a first side view of a handheld power tool according to some embodiments of the present disclosure,

FIG. 2 illustrates a second side view of the handheld power tool illustrated in FIG. 1, and

FIG. 3 illustrates a third side view of the handheld power tool illustrated in FIG. 1 and FIG. 2.

### DETAILED DESCRIPTION

Aspects of the present invention will now be described more fully. Like numbers refer to like elements throughout. Well-known functions or constructions will not necessarily be described in detail for brevity and/or clarity.

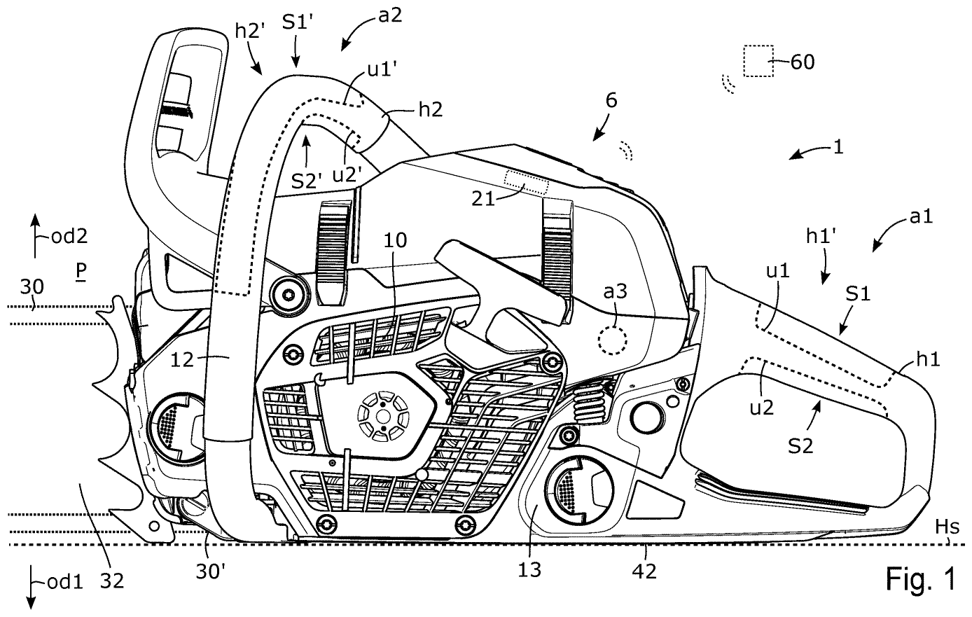

FIG. 1 illustrates a first side view of a handheld power tool 1 according to some embodiments of the present disclosure. The handheld power tool 1 comprises a tool 30 and a power source 10 configured to power the tool 30. According to the illustrated embodiments, the handheld power tool 1 is a chainsaw comprising a tool 30 in the form of a cutting chain movably arranged around a guide bar 32. In FIG. 1, the cutting chain and the guide bar 32 are schematically illustrated. The power source 10 is configured to rotate the cutting chain around the guide bar 32.

According to further embodiments, the handheld power tool 1, as referred to herein, may be another type of handheld power tool 1, such as for example a power cutter, a circular saw, a trimmer, a hedge trimmer, a multi-tool, or the like. Obviously, according to such embodiments, the handheld power tool 1 may comprise another type of tool 30 than a cutting chain, such as for example a circular saw blade, a trimmer head, a hedge trimmer cutting assembly, or the like.

According to the illustrated embodiments, the power source 10 of the handheld power tool 1 is an internal combustion engine. In more detail, according to the illustrated embodiments, the power source 10 is a small sized two-stroke internal combustion engine. The handheld power tool 1 comprises a fuel tank 13 configured to store fuel which is supplied to the internal combustion engine during operation thereof.

According to some further embodiments, the handheld power tool 1 may comprise another type of power source 10, such as an electric motor. According to such embodiments, the handheld power tool 1 may comprise an electric battery for supplying electricity to the electric motor during operation thereof. As an alternative, or in addition, the handheld power tool 1 may comprise another type of device for supplying electricity to the electric motor during operation thereof, such as a connector for connecting the electric motor to an electric power cord.

The handheld power tool 1 comprises a first handle h1 and a second handle h2. The second handle h2 is separate from the first handle h1 and is arranged at a distance from the first handle h1. The handheld power tool 1 is configured to be supported via each of the first and second handles h1, h2 during operation of the handheld power tool 1. In other words, the handheld power tool 1 is configured to be supported by two hands of a user during operation of the handheld power tool 1, i.e., is configured to be supported by one hand grabbing the first handle h1 and the other hand grabbing the second handle h2.

According to the illustrated embodiments, the first handle h1 is a rear handle arranged at a rear portion of the handheld power tool 1 and the second handle h2 is a so-called front handle. According to the illustrated embodiments, the second handle h2 is attached to a tool body of the handheld power tool 1 at a region of a tool portion 30′ of the handheld power tool 1. The tool portion 30′ is a portion of the handheld power tool 1 to which the tool 30 of the handheld power tool 1 is connected. In other words, according to the illustrated embodiments, the second handle h2 of the handheld power tool 1 is arranged closer to the tool 30 of the handheld power tool 1 than the first handle h1. Moreover, the second handle h2 is arranged at a position between the tool 30 of the handheld power tool 1 and the first handle h1 of the handheld power tool 1.

The first handle h1 comprises a gripping portion h1′ configured to be gripped by a hand of a user during operation of the handheld power tool 1. Likewise, the second handle h2 comprises a gripping portion h2′ configured to be gripped by a hand of a user during operation of the handheld power tool 1. The second handle h2 is formed by an elongated curved-shaped body allowing a user to grip the gripping portion h2′ of the second handle h2 from various directions in a convenient manner which allows a user to operate the handheld power tool 1 at different orientations relative to the gravitational field in a convenient and safe manner.

According to embodiments herein, the handheld power tool 1 comprises a first sensor assembly a1 configured to provide data representative of an external force applied onto the first handle h1 and a second sensor assembly a2 configured to provide data representative of an external force applied onto the second handle h2. According to the illustrated embodiments, the first sensor assembly a1 is arranged on the first handle h1 and the second sensor assembly a2 is arranged on the second handle h2. The data representative of external forces applied onto the first and second handles h1, h2 can give a clear indication of a current use situation of the handheld power tool 1 as is further explained herein.

According to the illustrated embodiments, the first sensor assembly a1 comprises two sensor units u1, u2 arranged on at least substantially opposite sides S1, S2 of the gripping portion h1′ of the first handle h1. In more detail, according to the illustrated embodiments, the first sensor assembly a1 comprises a first sensor unit u1 arranged on a first side S1 of the gripping portion h1′ of the first handle h1 and a second sensor unit u2 arranged on a second side S2 of the gripping portion h1′ of the first handle h1, wherein the second side S2 is opposite to the first side S1.

Likewise, according to the illustrated embodiments, the second sensor assembly a2 comprises two sensor units u1′, u2′ arranged on at least substantially opposite sides S1′, S2′ of the gripping portion h2′ of the second handle h2. In more detail, the second sensor assembly a2 comprises a first sensor unit u1′ arranged on a first side S1′ of the gripping portion h2′ of the second handle h2 and a second sensor unit u2′ arranged on a second side S2′ of the gripping portion h2′ of the second handle h2, wherein the second side S2′ is opposite to the first side S1′.

In FIG. 1, the handheld power tool 1 is illustrated as viewed straight towards a side of the handheld power tool 1. Moreover, in FIG. 1, the handheld power tool 1 is illustrated as positioned in a usual upright parking position on a flat horizontal support surface Hs. When the handheld power tool 1 is positioned in the usual upright parking position on a flat horizontal support surface Hs, a bottom side 42 of the handheld power tool 1 is resting, i.e., is abutting, against the flat horizontal support surface Hs. According to the illustrated embodiments, the second handle h2 is arranged at a distance from the first handle h1 as measured along a direction parallel to the bottom side 42 of the handheld power tool 1.

As mentioned, according to the illustrated embodiments, the handheld power tool 1 is a chainsaw comprising a tool 30 in the form of a cutting chain movably arranged around a guide bar 32. A cutting chain is a type of cutting tool configured to operate in a cutting plane P. In FIG. 1, the cutting plane P is perpendicular to the flat horizontal support surface Hs as well as to the viewing direction of FIG. 1.

Moreover, according to the illustrated embodiments, the tool 30 is arranged to operate in at least two different operational directions od1, od2. Each of the least two different operational directions od1, od2 coincides with the cutting plane P. According to the illustrated embodiments, the cutting plane P, and each of the least two different operational directions od1, od2, is substantially perpendicular to the bottom side 42 of the handheld power tool 1, i.e., is substantially perpendicular to a flat horizontal support surface Hs when the handheld power tool 1 is positioned in the usual upright parking position on the flat horizontal support surface Hs.

According to the illustrated embodiments, the cutting plane P extends through each of the first and second sensor assemblies a1, a2. In other words, according to the illustrated embodiments, the cutting plane P extends through each of the first and second sensor units u1, u2 of the first sensor assembly a1 and extends through each of the first and second sensor units u1′, u2′ of the second sensor assembly a2.

The first side S1 of the gripping portion h1′ of the first handle h1, as referred to herein, may be a side of the gripping portion h1′ of the first handle h1 facing in a direction away from the bottom side 42 of the handheld power tool 1. The first side S1 of the gripping portion h1′ of the first handle h1 may also be referred to as a top side of the gripping portion h1′ of the first handle h1. Likewise, the first side S1′ of the gripping portion h2′ of the second handle h2, as referred to herein, may be a side of the gripping portion h2′ of the second handle h2 facing in a direction away from the bottom side 42 of the handheld power tool 1. The first side S1′ of the gripping portion h2′ of the second handle h2 may also be referred to as a top side of the gripping portion h2′ of the second handle h2. Each of the first sides S1, S1′ of the gripping portions h1′, h2′ of the first and second handles h1, h2 may be configured to form an abutting surface for a palm of a hand of a user.

Moreover, the second side S2 of the gripping portion h1′ of the first handle h1, as referred to herein, may be a side of the gripping portion h1′ of the first handle h1 facing in a direction towards the bottom side 42 of the handheld power tool 1. The second side S2 of the gripping portion h1′ of the first handle h1 may also be referred to as a bottom side of the gripping portion h1′ of the first handle h1. Likewise, the second side S2′ of the gripping portion h2′ of the second handle h2, as referred to herein, may be a side of the gripping portion h2′ of the second handle h2 facing in a direction towards the bottom side 42 of the handheld power tool 1. The second side S2′ of the gripping portion h2′ of the second handle h2 may also be referred to as a bottom side of the gripping portion h2′ of the second handle h2. Each of the second sides S2, S2′ of the gripping portions h1′, h2′ of the first and second handles h1, h2 may be configured to form an abutting surface for fingers of a hand of a user.

The first and second handles h1, h2 of the handheld power tool 1 can be accessed in an easy manner when the handheld power tool 1 is positioned in the usual upright parking position on the flat horizontal support surface Hs because the intended grabbing directions of the gripping portions h1′, h2′ of the first and second handles h1, h2 are substantially perpendicular to the flat horizontal support surface Hs when the handheld power tool 1 is positioned in the usual upright parking position on the flat horizontal support surface Hs.

The reason for the use of the word “usual” herein in the expression “usual upright parking position” is that the handheld power tool 1 could possibly be positioned on a flat horizontal support surface Hs in another orientation relative to the flat horizontal support surface Hs, such as for example laid on the side on the flat horizontal support surface Hs. However, if so, the cutting plane P of the tool 30, and each of the least two different operational directions od1, od2 of the tool 30, as well as the intended grabbing directions of the gripping portions h1′, h2′ of the first and second handles h1, h2, will not be substantially perpendicular to the flat horizontal support surface Hs. Moreover, if so, the bottom side 42 of the handheld power tool 1 will apparently not rest against the flat horizontal support surface Hs.

According to the illustrated embodiments, each sensor unit u1, u2, u1′, u2′ of the first and second sensor assemblies a1, a2 comprises a force sensitive resistor. In other words, each of the first and second sensor units u1, u2 of the first sensor assembly a1 and the first and second sensor units u1′, u2′ of the second sensor assembly a2 comprises a force sensitive resistor.

A force sensitive resistor comprises a material whose resistance changes when a force is applied to the material. The resistance of a force sensitive resistor changes substantially linearly with the magnitude of the force applied to the force sensitive resistor. Force sensitive resistors are sometimes referred to as force-sensing resistors or simply FSR-resistors. Force sensitive resistors normally comprises of a conductive polymer, which changes resistance in a manner which follows the application of force to its surface.

Force sensitive resistors can be provided as a polymer sheet or ink that can be applied by screen printing. Moreover, force sensitive resistors normally comprise both electrically conducting and non-conducting particles suspended in a matrix. The particles are small sized, normally sub-micrometre sizes, and are arranged to reduce the temperature dependence and improve the mechanical properties of the force sensitive resistor. The applying of a force to the surface of the force sensitive resistor causes particles to touch conducting electrodes, which changes the resistance of the force sensitive resistor. Force sensitive resistors are durable and require a relatively simple interface and are associated with a low need for routing electrical wires, such as electrical wires for power supply. Moreover, force sensitive resistors normally have a small thickness. According to the illustrated embodiments, the thickness of the force sensitive resistor of each sensor unit u1, u2, u1′, u2′ is less than 1 mm. Moreover, force sensitive resistors can be provided in a cost-efficient manner and have a good shock resistance.

By utilizing force sensitive resistors in the first and second sensor assemblies a1, a2, a mechanical robust solution is provided requiring no moving parts for providing data representative of external forces applied onto the first and second handles h1, h2.

According to the illustrated embodiments, the force sensitive resistor of each of the first and second sensor units u1, u2 of the first sensor assembly a1 is arranged between a harder core structure of the first handle h1 and a softer outer layer of the first handle h1. The softer outer layer of the first handle h1 may be formed by an elastic material, such as an elastic polymer. The harder core structure of the first handle h1 may be formed by metal or a harder type of polymer. The use of the wording “harder” in this context means that the harder core structure has a higher stiffness than the softer outer layer of the first handle h1.

Likewise, according to the illustrated embodiments, the force sensitive resistor of each of the first and second sensor units u1′, u2′ of the second sensor assembly a2 is arranged between a harder core structure of the second handle h2 and a softer outer layer of the second handle h2. The softer outer layer of the second handle h2 may be formed by an elastic material, such as an elastic polymer. The harder core structure of the first handle h1 may be formed by metal or a harder type of polymer. The use of the wording “harder” in this context means that the harder core structure of the second handle h2 has a higher stiffness than the softer outer layer of the second handle h2.

According to further embodiments, the force sensitive resistor of one or more of the sensor units u1, u2, u1′, u2′ may be integrated into the softer outer layer of a handle h1, h2 of the handheld power tool 1. In both types of embodiments, the force sensitive resistors may be arranged inside an outer surface of each of the first and second handles h1, h2. By arranging the force sensitive resistors inside the outer surface of each of the first and second handles h1, h2, a robust and reliable solution is provided for obtaining data representative of external forces applied onto the first and second handles h1, h2.

The handheld power tool 1 comprises a control arrangement 21. The control arrangement 21 is operably connected to each of the first and second sensor assemblies a1, a2. That is, in more detail, the control arrangement 21 is configured to obtain data from each sensor unit u1, u2, u1′, u2′ of the first and second sensor assemblies a1, a2, wherein the data is representative of the resistance of the force sensitive resistor of each sensor unit u1, u2, u1′, u2′. In this manner, the control arrangement 21 can obtain data representative of external forces applied onto the first and second handles h1, h2.

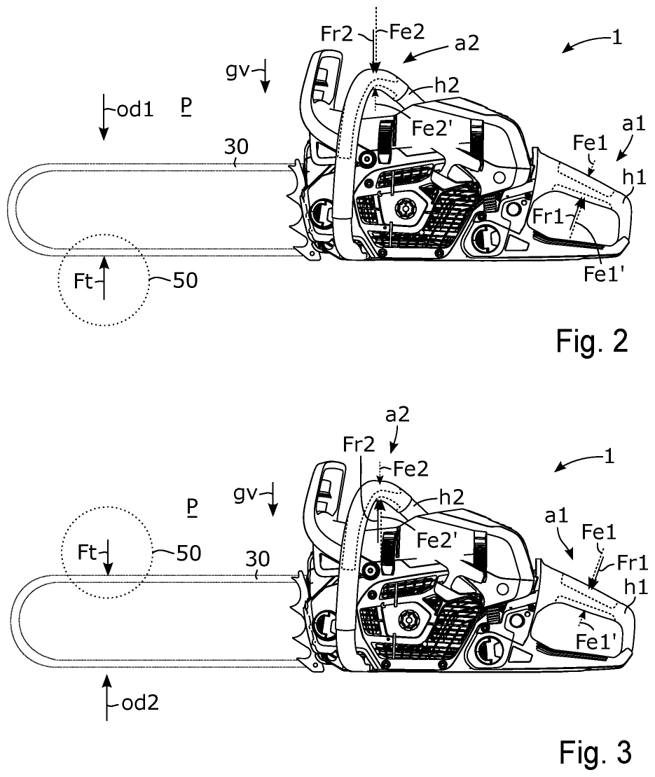

FIG. 2 illustrates a second side view of the handheld power tool 1 illustrated in FIG. 1. In FIG. 2, the handheld power tool 1 is illustrated as being held in a first use situation by a user, wherein the user is gripping the first handle h1 with one hand and the second handle h2 with the other hand. In FIG. 2, the hands of the user have been omitted for reasons of brevity and clarity.

In the first use situation illustrated in FIG. 2, the user is operating the tool 30 of the handheld power tool 1 in a first operational direction od1 of the least two different operational directions od1, od2 referred to above. Moreover, in the first use situation illustrated in FIG. 2, the user is using a lower side of the tool 30 for cutting an object 50. According to the illustrated embodiments, the lower side of the tool 30 has a normal vector being substantially parallel to a normal vector of the lower side 42 of the handheld power tool 1 indicated in FIG. 1.

In FIG. 2, a local gravity vector gv is indicated. In the first use situation illustrated in FIG. 2, the object 50 is located below the tool 30 of the handheld power tool 1 as seen relative to the local gravity vector gv. The object 50 may for example be a log, a branch of a tree, or the like. A force Ft is applied onto the tool 30 upon operating the tool 30 in the first operational direction od1. The direction of the force Ft applied onto the tool 30 is substantially opposite to the first operational direction od1. Moreover, in the first use situation illustrated in FIG. 2, the direction of the force Ft applied onto the tool 30 is substantially opposite to the direction of the local gravity vector gv.

FIG. 3 illustrates a third side view of the handheld power tool 1 illustrated in FIG. 1 and FIG. 2. In FIG. 3, the handheld power tool 1 is illustrated as being held in a second use situation by a user, wherein the user is gripping the first handle h1 with one hand and the second handle h2 with the other hand. In FIG. 3, the hands of the user have been omitted for reasons of brevity and clarity.

In the second use situation illustrated in FIG. 3, the user is operating the tool 30 of the handheld power tool 1 in a second operational direction od2 of the least two different operational directions od1, od2 referred to above. The second operational direction od2 indicated in FIG. 3 is opposite to the first operational direction od1 indicated in FIG. 2. In the second use situation illustrated in FIG. 3, the user is using an upper side of the tool 30 for cutting an object 50. According to the illustrated embodiments, the upper side of the tool 30 has a normal vector being substantially opposite to a normal vector of the lower side 42 of the handheld power tool 1 indicated in FIG. 1. Also in FIG. 3, a local gravity vector gv is indicated. In the second use situation illustrated in FIG. 3, the object 50 is located above the tool 30 of the handheld power tool 1 as seen relative to the local gravity vector gv. The object 50 may for example be a log, a branch of a tree, or the like.

A force Ft is applied onto the tool 30 upon operating the tool 30 in the second operational direction od2. The direction of the force Ft applied onto the tool 30 is substantially opposite to the second operational direction od2. Moreover, in the second use situation illustrated in FIG. 3, the direction of the force Ft applied onto the tool 30 substantially coincides with the direction of the local gravity vector gv.

In FIG. 2 and FIG. 3, external forces Fe1, Fe1′ applied onto the first handle h1 and external forces Fe2, Fe2′ applied onto the second handle h2 are indicated. Below, simultaneous reference is made to FIG. 1-FIG. 3, if not indicated otherwise.

The external force Fe1 is representative of an external force applied to the first side S1 of the gripping portion h1′ of the first handle h1. The external force Fe1′ is representative of an external force applied to the second side S2 of the gripping portion h1′ of the first handle h1. The external force Fe2 is representative of an external force applied to the first side S1′ of the gripping portion h2′ of the second handle h2. The external force Fe2′ is representative of an external force applied to the second side S2′ of the gripping portion h2′ of the second handle h2.

As mentioned, the first sensor assembly a1 is configured to provide data representative of external forces Fe1, Fe1′ applied onto the first handle h1 whereas the second sensor assembly a2 is configured to provide data representative of external forces Fe2, Fe2′ applied onto the second handle h2. In more detail, according to the illustrated embodiments, each of the first and second sensor assemblies a1, a2 is configured provide data representative of external forces Fe1, Fe1′, Fe2, Fe2′ applied to the respective first and second handles h1, h2 in directions parallel to the cutting plane P.

According to the illustrated embodiments, the control arrangement 21 is configured to provide a tool force estimate representative of a force Ft applied onto the tool 30 based on the data from the first and second sensor assemblies a1, a2. In other words, according to the illustrated embodiments, the control arrangement 21 is configured to provide a tool force estimate representative of a force Ft applied onto the tool 30 based on the data from the sensor units u1, u2, u1′, u2′ of the first and second sensor assemblies a1, a2, wherein the data is representative of the current external forces Fe1, Fe1′, Fe2, Fe2′ applied onto the first and second handles h1, h2. The tool force estimate may be indicative of a current operational direction od1, od2 of the tool 30, as is further explained herein. As an alternative, or in addition, the tool force estimate may be indicative of an estimated magnitude of a force Ft applied onto the tool 30.

The length of the arrows in FIG. 2 and FIG. 3, which indicate the external forces Fe1, Fe1′, Fe2, Fe2′, is representative of a magnitude of the respective external force Fe1, Fe1′, Fe2, Fe2′. As seen in FIG. 2, two opposing external forces Fe1, Fe1′ are applied onto the first handle h1. The two opposing external forces Fe1, Fe1′ applied onto the first handle h1 are caused by the fact that the user grips the gripping portion h1′ of the first handle h1 in the first use situation depicted in FIG. 2.

However, as seen when comparing FIG. 2 and FIG. 1, the external force Fe1′ acting on the second side S2 of the gripping portion h1′ of the first handle h1 has a greater magnitude than the external force Fe1 acting on the first side S1 of the gripping portion h1′ of the first handle h1. In other words, in the first use situation depicted in FIG. 2, the user is gripping the gripping portion h1′ of the first handle h1 while gently lifting the first handle h1 upwards, i.e., in a direction substantially opposite to the local gravity vector gv.

Moreover, in FIG. 2, a resultant force Fr1 applied onto the first handle h1 is indicated. The resultant force Fr1 is the sum of the external force Fe1′ acting on the second side S2 of the gripping portion h1′ of the first handle h1 and the external force Fe1 acting on the first side S1 of the gripping portion h1′ of the first handle h1.

Likewise, as seen in FIG. 2, two opposing external forces Fe2, Fe2′ are applied onto the second handle h2. The two opposing external forces Fe2, Fe2′ applied onto the second handle h2 are caused by the fact that the user grips the gripping portion h2′ of the second handle h2 in the first use situation depicted in FIG. 2.

However, as seen when comparing FIG. 2 and FIG. 1, the external force Fe2′ acting on the second side S2′ of the gripping portion h2′ of the second handle h2 has a smaller magnitude than the external force Fe2 acting on the first side S1′ of the gripping portion h2′ of the second handle h2. In other words, in the first use situation depicted in FIG. 2, the user is gripping the gripping portion h2′ of the second handle h2 while gently pressing the second handle h2 downwards, i.e., in a direction substantially coinciding with the local gravity vector gv.

A resultant force Fr2 applied onto the second handle h2 is indicated in FIG. 2. The resultant force Fr2 is the sum of the external force Fe2 acting on the first side S1′ of the gripping portion h2′ of the second handle h2 and the external force Fe2′ acting on the second side S2′ of the gripping portion h2′ of the second handle h2.

The following is explained with reference to FIG. 3 and FIG. 1. As seen when comparing FIG. 3 and FIG. 1, the external force Fe1′ acting on the second side S2 of the gripping portion h1′ of the first handle h1 has a smaller magnitude than the external force Fe1 acting on the first side S1 of the gripping portion h1′ of the first handle h1 in the second use situation depicted in FIG. 3. In other words, in the second use situation depicted in FIG. 3, the user is gripping the gripping portion h1′ of the first handle h1 while gently pressing the first handle h1 downwards, i.e., in a direction substantially coinciding with the local gravity vector gv.

In FIG. 3, a resultant force Fr1 applied onto the first handle h1 is indicated. The resultant force Fr1 is the sum of the external force Fe1 acting on the first side S1 of the gripping portion h1′ of the first handle h1 and the external force Fe1′ acting on the second side S2 of the gripping portion h1′ of the first handle h1.

Likewise, as seen in FIG. 3, two opposing external forces Fe2, Fe2′ are applied onto the second handle h2. The two opposing external forces Fe2, Fe2′ applied onto the second handle h2 are caused by the fact that the user grips the gripping portion h2′ of the second handle h2 in the second use situation depicted in FIG. 3.

However, as seen when comparing FIG. 3 and FIG. 1, the external force Fe2′ acting on the second side S2′ of the gripping portion h2′ of the second handle h2 has a greater magnitude than the external force Fe2 acting on the first side S1′ of the gripping portion h2′ of the second handle h2. In other words, in the second use situation depicted in FIG. 3, the user is gripping the gripping portion h2′ of the second handle h2 while gently lifting the second handle h2 upwards, i.e., in a direction substantially opposite to the local gravity vector gv.

A resultant force Fr2 applied onto the second handle h2 is indicated in FIG. 3. The resultant force Fr2 is the sum of the external force Fe2′ acting on the second side S2′ of the gripping portion h2′ of the second handle h2 and the external force Fe2 acting on the first side S1′ of the gripping portion h2′ of the second handle h2.

The size and directions of the resultant forces Fr1, Fr2 applied onto the first and second handles h1, h2 indicate the size and direction of the force Ft applied onto the tool 30.

As mentioned, according to the illustrated embodiments, the control arrangement 21 is configured to provide a tool force estimate representative of a force Ft applied onto the tool based on the data from the sensor units u1, u2, u1′, u2′ of the first and second sensor assemblies a1, a2, wherein the data is representative of the current external forces Fe1, Fe1′, Fe2, Fe2′ applied onto the first and second handles h1, h2. The control arrangement 21 may be configured to provide the tool force estimate using calculations and/or table data. The calculations and/or table data may be adapted to account for the mass of the handheld power tool 1 and/or a centre of mass of the handheld power tool 1.

According to some embodiments, the control arrangement 21 is configured to provide a first resultant force estimate representative of a resultant force Fr1 applied onto the first handle h1 by comparing force data obtained from the two sensor units u1, u2 of the first sensor assembly a1. According to these embodiments, the control arrangement 21 may be configured to provide a tool force estimate representative of a force Ft applied onto the tool at least partially based on the first resultant force estimate.

Likewise, according to some embodiments, the control arrangement 21 is configured to provide a second resultant force estimate representative of a resultant force Fr2 applied onto the second handle h2 by comparing force data obtained from the two sensor units u1, u2 of the second sensor assembly a2. According to such embodiments, the control arrangement 21 may be configured to provide a tool force estimate representative of a force Ft applied onto the tool 30 at least partially based on the second resultant force estimate.

Moreover, according to some further embodiments, the handheld power tool 1 may comprise one or more other types of devices configured to provide data to the control arrangement 21 indicative of a current force Ft applied onto the tool 30, wherein the control arrangement 21 is configured to provide the tool force estimate at least partially based on the data. As an example, according to some embodiments, the handheld power tool 1 comprises a sensor configured to sense a current orientation of the handheld power tool 1 relative to a local gravity vector gv. Such a sensor may for example comprise an accelerometer and/or a gyroscope. According to such embodiments, the control arrangement 21 of the handheld power tool 1 may be configured to provide the tool force estimate at least partially based on data from the sensor. In this manner, even more reliable tool force estimates can be provided.

As understood from the above, according to the illustrated embodiments, each of the first and second handles h1, h2 comprises one pair of sensor units u1, u2, u1′, u2′ arranged opposite to each other on the gripping portion h1′, h2′ of the respective first and second handles h1, h2. According to further embodiments, one or both of the first and second handles h1, h2 may comprise one or more additional sensor units along the length of the gripping portion h1′, h2′ of the handle h1, h2. For example, the second handle h2 may comprise one or more additional sensor units, such as a pair of opposing sensor units, arranged at another portion of the elongated curved-shaped body of the second handle h2 than the pair of opposing sensor units u1′, u2′ explained above.

The handheld power tool 1 according to the embodiments illustrated in FIG. 1-FIG. 3 can be operated at an orientation relative to a local gravitational field in which the cutting plane P and the operational directions od1, od2 of the tool 30 are substantially perpendicular to a local gravity vector gv. Such an orientation of the handheld power tool 1 may also be referred to as a horizontal orientation because the cutting plane P and the operational directions od1, od2 of the tool 30 are substantially parallel to a horizontal plane when the handheld power tool 1 is oriented in this manner relative to the gravitational field. In FIG. 1, a side portion 12 of the second handle h2 is indicated. The side portion 12 of the second handle h2 is intended to be gripped when the handheld power tool 1 is operated at such a horizontal orientation relative to a local gravitational field. According to some embodiments, one or more additional sensor units according to the above is arranged at the side portion 12 of the second handle h2.

The control arrangement 21 may be operably connected to such one or more additional sensor units and may be configured to estimate a current orientation of the handheld power tool 1 relative to a local gravity field based on data from such one or more additional sensor units. Furthermore, according to these embodiments, the control arrangement 21 may be configured to provide a tool force estimate based on data from the sensor units u1, u2 arranged on the first handle h1, i.e., based on data from the first sensor assembly a1, when one or more additional sensor units on the side portion 12 of the second handle h2 indicates that the side portion 12 is being gripped.

As is indicated in FIG. 1, according to the illustrated embodiments, the handheld power tool 1 comprises a user interface unit 6. The user interface unit 6 may comprise one or more of a display, a light emitting unit, a light emitting diode, a speaker, and a communication device configured to wirelessly transmit data to an external device 60. The communication device may transmit data wirelessly over a wireless connection such as the internet, or a wireless local area network (WLAN), or a wireless connection for exchanging data over short distances using short-wavelength, i.e. ultra-high frequency (UHF) radio waves in the industrial, scientific, and medical (ISM) band from 2.4 to 2.485 GHz. The external device 60 may for example comprise a computer, a computer tablet, a smartphone, earphones, headphones, or the like.

According to some embodiments, the user interface unit 6 is configured to output data indicative of the external forces Fe1, Fe1′, Fe2, Fe2′ applied onto the first and second handles h1, h2. In this manner, a user of the handheld power tool 1 can receive information indicating the current external forces Fe1, Fe1′, Fe2, Fe2′ applied onto the first and second handles h1, h2.

Moreover, according to some embodiments, the user interface unit 6 is configured to output data indicative of the tool force estimate. Thereby, a handheld power tool 1 is provided having conditions for being used in a simpler, more ergonomic, and more user-friendly manner. This is because the output of the data indicative of the tool force estimate can indicate whether an actual force Ft applied onto the tool 30 is within a preferred force range. As a further result, a handheld power tool 1 is provided having conditions for an improved operational efficiency as well as conditions for a reduced wear and tear of the tool 30. In addition, a handheld power tool 1 is provided having conditions for being operated in a safer manner.

In embodiments in which the user interface unit 6 comprises a display, one or more light emitting units, or the like, the data indicative of the tool force estimate may be outputted in the form of a visual representation of the tool force estimate. The visual representation of the tool force estimate may for example be in the form of a number, a symbol, a text, a light intensity, and/or a colour.

In embodiments in which the user interface unit 6 comprises a speaker, or the like, the data indicative of the tool force estimate may be outputted in the form of an audible representation of the tool force estimate. The audible representation of the tool force estimate may for example be in the form of a tone, a frequency, a speaker voice, a sound intensity, or the like.

In embodiments in which the user interface unit 6 comprises a communication device configured to wirelessly transmit data to an external device 60, the data indicative of the tool force estimate may be adapted such that a visual and/or audible representation of the tool force estimate, for example according to the above, is outputted by the external device 60 when the data is received in the external device 60.

According to some embodiments, the user interface unit 6 is configured to output a first type of signal if the tool force estimate is below a threshold force and is configured to output a second type of signal, being distinguishable from the first type of signal, if the tool force estimate exceeds the threshold force. In embodiments in which the user interface unit 6 comprises a display, one or more light emitting units, or the like, each of the first and second types of signals may comprise a visual representation such as a number, a symbol, a text, a light intensity, and/or a colour.

In embodiments in which the user interface unit 6 comprises a speaker, or the like, each of the first and second types of signals may comprise an audible representation for example in the form of a tone, a frequency, a speaker voice, a sound intensity, or the like.

In embodiments in which the user interface unit 6 comprises a communication device configured to wirelessly transmit data to an external device 60, the first and second signals may comprise data adapted such that a first type of visual and/or audible representation is outputted by the external device 60 when the external device 60 receives the first type of signal and wherein the a second type of visual and/or audible representation is outputted by the external device 60 when the external device 60 receives the second type of signal.

The user interface unit 6 of the handheld power tool 1 may comprise a combination of the above described, i.e., may comprise a combination of two or more of a visual output unit on the handheld power tool 1, an audible output unit on the handheld power tool 1, and a communication device configured to wirelessly transmit data to an external device 60.

The user interface unit 6 may be configured to continuously output data, such as data indicative of the tool force estimate. In this manner, a continuous interaction can be made with a user of the handheld power tool 1, which facilitates the use of the handheld power tool 1. Moreover, a handheld power tool 1 is provided having conditions for an improved operational efficiency as well as conditions for a reduced wear and tear of the tool 30. In addition, a handheld power tool 1 is provided having conditions for being operated in a safer manner.

According to some embodiments, the control arrangement 21 is configured to adjust a power output of the power source 10 based on the tool force estimate. According to these embodiments, the control arrangement 21 may be configured to increase the power output of the power source 10 with increasing tool force estimates and may be configured to reduce the power output of the power source 10 with decreasing tool force estimates. Accordingly, in this manner, an at least substantially automatic control can be performed of the power output of the power source 10 of the handheld power tool based on the tool force estimate being representative of a force Ft applied onto the tool 30. Accordingly, due to these features, a handheld power tool 1 is provided having conditions for being operated in a simpler, more ergonomic, and more user-friendly manner.

As mentioned, according to the illustrated embodiments, the power source 10 is an internal combustion engine. According to these embodiments, the control arrangement 21 may be configured to adjust the power output of the internal combustion engine by adjusting the amount of air, and/or fuel, supplied to a cylinder of the internal combustion engine. In embodiments in which the power source 10 of the handheld power tool 1 is an electric motor, the control arrangement 21 may be configured to adjust the power output of the electric motor by controlling the amount of electric current, and/or electric voltage, supplied to the electric motor.

According to some embodiments, the control arrangement 21 of the handheld power tool 1 is configured to estimate an operational efficiency of the tool 30 based on the tool force estimate and on current operational data of the power source 10. In embodiments in which the power source 10 is an internal combustion engine, the current operational data of the power source may comprise one or more of a current rotational speed of the internal combustion engine, a current torque of the internal combustion engine, a current power of the internal combustion engine, a current temperature of the internal combustion engine, a current throttle position of an air supply system of the internal combustion engine, a current throttle position of an actuator for controlling the power output of the internal combustion engine, and the like.

In embodiments in which the power source 10 of the handheld power tool 1 is an electric motor, the current operational data of the power source may comprise one or more of a current rotational speed of the electric motor, a current torque of the electric motor, a current power of the electric motor, a current temperature of the electric motor, a current throttle position of an actuator for controlling the electric motor, a current electrical voltage supplied to the electric motor, a current electrical current supplied to the electrical motor, and the like.

A reduced operational efficiency of the tool 30 may for example be caused by clogging of the tool 30 and/or wear and tear of the tool 30. Wear and tear of the tool 30 may for example reduce the sharpness of the tool 30. According to some embodiments, the user interface unit 6 of the handheld power tool 1 is configured to output data indicative of the estimated operational efficiency of the tool 30. Thereby, a handheld power tool 1 is provided having conditions for being used in a simpler and more user-friendly manner. In addition, a handheld power tool 1 is provided having conditions for a reduced energy consumption. This is because a user can be notified about the operational efficiency of the tool 30 and can perform measures in response thereto, such as for example cleaning, replacing, or sharpening the tool 30 of the handheld power tool 1.

According to some embodiments, the user interface unit 6 is configured to continuously output data indicative of the data indicative of the estimated operational efficiency of the tool 30. In this manner, a continuous interaction can be made with a user of the handheld power tool 1. As an alternative, or in addition, the user interface unit 6 may be configured to output a notification in case the estimated operational efficiency of the tool 30 drops below a threshold efficiency. In this manner, the user of the handheld power tool 1 can be notified in case the estimated operational efficiency of the tool 30 indicates that it is time to clean, replace, or sharpen the tool 30 of the handheld power tool 1.

According to some embodiments, the control arrangement 21 of the handheld power tool 1 is configured to render the power source 10 inoperable in case no external force is applied onto one of the first and second handles h1, h2. In other words, according to these embodiments, the control arrangement 21 of the handheld power tool 1 is configured to render the power source 10 inoperable in case the data from the first and second sensor assemblies a1, a2 indicates that no external force is applied onto one of the first and second handles h1, h2. Thereby, a handheld power tool 1 is provided having conditions for a significantly enhanced operational safety. This is because it can be ensured that the handheld power tool 1 is held using one hand on the first handle h1 and one hand on the second handle h2 during operation of the handheld power tool 1.

Moreover, according to some embodiments, the control arrangement 21 of the handheld power tool 1 may be configured to render the power source 10 inoperable in case of a detection of a sudden increase in external force Fe1, Fe1′, Fe2, Fe2′ applied onto one of the first and second handles h1, h2. Thereby, a handheld power tool 1 is provided having conditions for a significantly enhanced operational safety. This is because the power source is rendered inoperable in potentially dangerous situations, such as when a sudden increase in external force Fe1, Fe1′, Fe2, Fe2′ applied onto one of the first and second handles h1, h2 is caused by a sudden movement of the handheld power tool 1, such as a sudden rotation of the handheld power tool 1. Such sudden movements of the handheld power tool 1 may for example occur if the moving tool 30 of the handheld power tool 1 is striking an object 50 at an unfavourable part of the tool 30, such as a tip of the tool 30. Sudden movements of the handheld power tool 1 according to the above described are sometimes referred to as a kickback.

According to some embodiments, the control arrangement 21 of the handheld power tool 1 is configured to adjust a power output of the power source 10 based on the data from the first sensor assembly a1. According to these embodiments, the control arrangement 21 may be configured to adjust the power output of the power source 10 based on an estimated gripping force around the gripping portion h1′ of the first handle h1. The control arrangement 21 may be configured to estimate the gripping force around the gripping portion h1′ of the first handle h1 using data from the first and second sensor units u1, u2 of the first sensor assembly a1.

Due to these features, a handheld power tool 1 is provided having conditions for being operated in a more ergonomic and user-friendly manner. This is because the adjustment of the power output of the power source 10 based on the data from the first sensor assembly a1 circumvents the need for a traditional throttle actuator for adjusting the power output of the power source 10. Accordingly, in this manner, the user does not need to adjust the power output of the power source 10 by actuating a separate actuator, for example using a finger. Instead, the user is allowed to control the power output of the power source 10 by adjusting the gripping force of the hand gripping the gripping portion h1′ of the first handle h1.

Furthermore, since the need for a traditional throttle actuator is circumvented for adjusting the power output of the power source 10, a handheld power tool 1 is provided having conditions and characteristics suitable for being manufactured and assembled in a cost-efficient manner. As seen in FIG. 1-FIG. 3, according to the illustrated embodiments, the handheld power tool 1 lacks a traditional throttle actuator at the first handle h1.

According to the illustrated embodiments, as indicated in FIG. 1, the handheld power tool 1 comprises a third sensor assembly a3. The third sensor assembly a3 is operably connected to the control arrangement 21 and comprises a force sensitive resistor. The control arrangement 21 may be configured to adjust a setting, or switch between at least two different states, based on input from the third sensor assembly a3. The at least two different states may for example comprise an activated state in which the handheld power tool 1 is activated for operation and a deactivated state in which the handheld power tool 1 is deactivated and thereby rendered inoperable.

According to the illustrated embodiments, the third sensor assembly a3 is arranged at a side portion of the handheld power tool 1. According to further embodiments, the third sensor assembly a3, as referred to herein, may comprise one or more force sensitive resistors arranged at a different portion of the handheld power tool 1. For example, the third sensor assembly a3, as referred to herein, may comprise one or more force sensitive resistors at the user interface unit 6 of the handheld power tool 1.

By utilizing force sensitive resistors in the third sensor assembly a3, a mechanical robust input unit for the control arrangement 21 is provided requiring no moving parts. Moreover, the third sensor assembly a3 can be provided with variable switch limits allowing input based on a pressing force against the third sensor assembly a3.

Force sensitive resistors of the third sensor assembly a3 may be integrated into a softer outer layer of the handheld power tool 1 or may be arranged between a softer outer layer of the handheld power tool 1 and a harder structural part of the handheld power tool 1. The use of the wording “softer” in this context means that the softer outer layer of the handheld power tool 1 has a lower stiffness than the harder structural part of the handheld power tool 1.

The wording “substantially coincides with”, as used herein, may encompass that the angle between the objects referred to is less than 10 degrees, or is less than 7 degrees.

The wording “substantially parallel to”, as used herein, may encompass that the angle between the objects referred to is less than 10 degrees, or is less than 7 degrees.

The wording “substantially perpendicular to”, as used herein, may encompass that the angle between the objects referred to is within the range of 80-100 degrees or is within the range of 83-97 degrees.

The wording “substantially opposite to”, as used herein, may encompass that the smallest angle between the objects referred to is larger than 165 degrees, or is larger than 173 degrees.

The wording “substantially opposite sides”, as used herein, may encompass that one of the sides is arranged within the range of 130-180 degrees, or is arranged within the range of 150-180 degrees, from the other side.

As mentioned, a first use situation of the handheld power tool 1 is illustrated in FIG. 2 and a second use situation of the handheld power tool 1 is illustrated in FIG. 3. Obviously, the handheld power tool 1 according to embodiments herein may be used in considerably more use situations than the first and second use situations depicted in FIG. 2 and FIG. 3. As an example, the handheld power tool 1 according to embodiments herein may be operated at other orientations relative to a local gravity vector gv than depicted in FIG. 2 and FIG. 3.

One skilled in the art will appreciate the control arrangement 21 may be configured to use programmed instructions when performing a specific task explained herein, for example when providing a tool force estimate representative of a force Ft applied onto the tool 30 based on the data from the first and second sensor assemblies a1, a2. These programmed instructions are typically constituted by a computer program, which, when it is executed in the control arrangement 21, ensures that the control arrangement 21 carries out the specific task. The computer program may be part of a computer program product which comprises a suitable digital storage medium on which the computer program is stored.

The control arrangement 21 may comprise a calculation unit which may take the form of substantially any suitable type of processor circuit or microcomputer, e.g., a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 21 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g., a memory card, a flash memory, a USB memory, a hard disc, or another similar volatile or non-volatile storage unit for storing data such as e.g., ROM (Read-Only Memory), PROM (Programmable Read-Only Memory), EPROM (Erasable PROM), EEPROM (Electrically Erasable PROM), etc. in different embodiments.

The control arrangement 21 is connected to components of the handheld power tool 1 for receiving and/or sending input and output signals. As an example, the control arrangement 21 is connected to the user interface unit 6 and to the sensor units u1, u2, u1′, u2′ of the first and second sensor assemblies a1, a2. These input and output signals may comprise waveforms, pulses, or other attributes which the input signal receiving devices can detect as information and which can be converted to signals processable by the control arrangement 21. These signals may then be supplied to the calculation unit. One or more output signal sending devices may be arranged to convert calculation results from the calculation unit to output signals for conveying to other parts of the control system of the handheld power tool 1 and/or the component or components for which the signals are intended. Each of the connections to the respective components of the handheld power tool 1 for receiving and sending input and output signals may take the form of one or more from among a cable, a data bus, e.g., a CAN (controller area network) bus, or some other bus configuration, or a wireless connection.

In the embodiments illustrated, the handheld power tool 1 comprises a control arrangement 21 but might alternatively be implemented wholly or partly in two or more control arrangements or two or more control units.

The feature that the user interface unit 6 is configured to output data may also be expressed as that the control arrangement 21 is configured to output data via the user interface unit 6.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A handheld power tool comprising:
a tool,
a power source configured to power the tool,
a first handle, and
a second handle arranged at a distance from the first handle,
wherein the handheld power tool is configured to be supported via each of the first and second handles during operation of the handheld power tool,
and wherein the handheld power tool further comprises:
a first sensor assembly configured to provide data representative of an external force applied onto the first handle, and
a second sensor assembly configured to provide data representative of an external force applied onto the second handle.

2. The handheld power tool according to claim 1, wherein the handheld power tool comprises a control arrangement configured to provide a tool force estimate representative of a force applied onto the tool based on the data from the first and second sensor assemblies.

3. The handheld power tool according to claim 2, wherein the control arrangement is configured to adjust a power output of the power source based on the tool force estimate.

4. The handheld power tool according to claim 2, wherein the tool is arranged to operate in at least two different operational directions, and wherein the tool force estimate is indicative of a current operational direction of the tool.

5. The handheld power tool according to claim 2, wherein the control arrangement is configured to estimate an operational efficiency of the tool based on the tool force estimate and on current operational data of the power source.

6. The handheld power tool according to claim 2, wherein the handheld power tool comprises a user interface unit configured to output data indicative of the tool force estimate.

7. The handheld power tool according to claim 6, wherein the user interface unit is configured to output a first type of signal if the tool force estimate is below a threshold force and is configured to output a second type of signal, being distinguishable from the first type of signal, if the tool force estimate exceeds the threshold force.

8. The handheld power tool according to claim 1, wherein the handheld power tool comprises a control arrangement configured to render the power source inoperable in case the data from the first and second sensor assemblies indicates that no external force is applied onto one of the first and second handles.

9. The handheld power tool according to claim 1, wherein the handheld power tool comprises a control arrangement configured to render the power source inoperable in case of a detection of a sudden increase in external force applied onto one of the first and second handles.

10. The handheld power tool according to claim 1, wherein the tool is a cutting cool configured to operate in a cutting plane, and wherein each of the first and second sensor assemblies is configured provide data representative of external forces applied to the respective first and second handles in directions parallel to the cutting plane.

11. The handheld power tool according to claim 10, wherein the cutting plane extends through each of the first and second sensor assemblies.

12. The handheld power tool according to claim 1, wherein the first handle comprises a gripping portion configured to be gripped by a hand of a user during operation of the handheld power tool, and wherein the first sensor assembly comprises two sensor units arranged on at least substantially opposite sides of the gripping portion of the first handle.

13. The handheld power tool according to claim 12, wherein the handheld power tool comprises a control arrangement configured to provide a first resultant force estimate representative of a resultant force applied onto the first handle by comparing force data obtained from the two sensor units, and wherein the control arrangement is configured to provide a tool force estimate representative of a force applied onto the tool at least partially based on the first resultant force estimate.

14. The handheld power tool according to claim 1, wherein the second handle comprises a gripping portion configured to be gripped by a hand of a user during operation of the handheld power tool, and wherein the second sensor assembly comprises two sensor units arranged on at least substantially opposite sides of the gripping portion of the second handle.

15. The handheld power tool according to claim 14, wherein the handheld power tool comprises a control arrangement configured to provide a second resultant force estimate representative of a resultant force applied onto the second handle by comparing force data obtained from the two sensor units, and wherein the control arrangement is configured to provide a tool force estimate representative of a force applied onto the tool at least partially based on the second resultant force estimate.

16. The handheld power tool according to claim 1, wherein the first and second sensor assemblies comprises a number of sensor units, and wherein each sensor unit comprises a force sensitive resistor.

17. The handheld power tool according to claim 1, wherein the handheld power tool comprises a control arrangement configured to adjust a power output of the power source based on the data from the first sensor assembly.

18. The handheld power tool according to claim 1, wherein the handheld power tool comprises a third sensor assembly and a control arrangement operably connected to the third sensor assembly, the third sensor assembly comprising at least one force sensitive resistor, and wherein the control arrangement is configured to adjust a setting, or switch between at least two different states, based on input from the third sensor assembly.

19. The handheld power tool according to claim 1, wherein the handheld power tool is a chain saw or a power cutter.
